(19) United States
(12) Patent Application Publication
(10) Pub. No.: US 2018/0086145 A1
(43) Pub. Date: Mar. 29, 2018

(54) MOTORCYCLE TIRE

(71) Applicant: BRIDGESTONE CORPORATION, Tokyo (JP)

(72) Inventors: Takahiro DAIRIKI, Tokyo (JP); Dyta ITOI, Tokyo (JP)

(73) Assignee: BRIDGESTONE CORPORATION, Tokyo (JP)

(21) Appl. No.: 15/559,159

(22) PCT Filed: Mar. 16, 2016
(86) PCT No.: PCT/JP2016/058382

§ 371 Date: Sep. 18, 2017

(30) Foreign Application Priority Data
Mar. 20, 2015 (JP) 2015-058788

(51) Int. Cl. B60C 11/03

(52) U.S. Cl. CPC B60C 11/0302; B60C 2011/0374; B60C 2200/10; B60C 11/0304

(57) ABSTRACT

A motorcycle tire whose wear resistance and drainage performance are improved by refining the tread pattern, including: a tread section; side wall sections and bead sections that continuously extend on both sides of the tread section, and the rotation direction of the tire when fitted to a motorcycle is designated. At least two inclined main grooves inclined with respect to the tire circumferential direction and at least two shallow grooves are arranged on the surface of the tread section and, when, among the at least two inclined main grooves, the one whose tire width direction inner end is closest to the tire equatorial plane is defined as a first inclined main groove, the at least two shallow grooves include: a center-side shallow groove and a shoulder-side shallow groove.

### TECHNICAL FIELD

The present invention relates to a motorcycle tire (hereinafter, also simply referred to as “tire”). More particularly, the present invention relates to a motorcycle tire having an improved tread pattern.

### BACKGROUND ART

Because of the characteristic of two-wheeled vehicles to make turns by tilting the body, which is different from four-wheeled vehicles such as passenger cars and trucks, motorcycle tires have a shape in which the crown section has a smaller curvature and a rounder cross-section than four-wheeled vehicle tires. Therefore, depending on the position of the ground-contacting portion in a ground contact state, the slipping parts in the ground-contacting surface may be uneven particularly when a large driving force is applied, and this is likely to cause uneven wear in which specific parts are rapidly worn out. In such motorcycle tires, a variety of tread patterns are formed by adopting multiple combinations of the number and the shape of grooves arranged in the tire tread section so as to improve various tire performances, such as drainage performance in wet conditions and wear resistance.

For example, aiming to provide a motorcycle tire in which thermal degradation of the tread section can be inhibited while maintaining the turning performance and the serviceable life of the tire, Patent Document 1 discloses a motorcycle tire that comprises a tread section and has a designated rotation direction, the outer surface of which tread section is curved in a circular arc shape convex toward the tire radial direction outer side and the outer end of which tread section forms the maximum tire width, wherein inner inclined main grooves which are constituted by prescribed first and second inner inclined main grooves each extending toward the respective tread ends on each side of the tire equator are arranged in the tread section, the first and the second inclined main grooves are alternately arranged in the tire circumferential direction and each have a prescribed length in the tire circumferential direction, prescribed inclined narrow grooves of a prescribed groove width are arranged in the regions between the inner inclined main grooves that are adjacent in the tire circumferential direction on each side of the tire equator, and the ground-contact surface during straight forward movement has a land ratio of 85 to 95%.

### RELATED ART DOCUMENT

### Patent Document

Patent Document 1: Japanese Unexamined Patent Application Publication No. 2013-180664

### SUMMARY OF THE INVENTION

### Problems to be Solved by the Invention

Generally speaking, for improvement of the wear resistance of a tire, it is effective to increase the land portion of the tread section; however, the groove ratio in the tread section decreases as the land portion is increased. This makes it difficult to maintain the drainage performance, and it is thus extremely difficult to satisfy both wear resistance and drainage performance. These problems are not sufficiently examined also in Patent Document 1, and it is desired to achieve a further improvement in both wear resistance and drainage performance.

In view of the above, an object of the present invention is to provide a motorcycle tire whose wear resistance and drainage performance are improved by refining the tread pattern.

### Means for Solving the Problems

The present inventors intensively studied to solve the above-described problems and consequently discovered that, by arranging inclined main grooves and shallow grooves having a smaller depth than the inclined main grooves in the tread section under prescribed conditions, the wear resistance and the drainage performance can be further improved and the problems can be solved as a result, thereby completing the present invention.

That is, the motorcycle tire of the present invention is a motorcycle tire which comprises: a tread section; and side wall sections and bead sections that continuously extend on both sides of the tread section, and whose rotation direction when fitted to a motorcycle is designated, the motorcycle tire being characterized in that:

at least two inclined main grooves that are inclined with respect to the tire circumferential direction and at least two shallow grooves are arranged on the surface of the tread section; and

when, among the at least two inclined main grooves, the one whose tire width direction inner end is closest to the tire equatorial plane is defined as a first inclined main groove, the at least two shallow grooves comprise: a center-side shallow groove which exists on the tire width direction outer side relative to the first inclined main groove and at least in a central part; and a shoulder-side shallow groove which exists on the tire width direction inner side relative to the first inclined main groove and at least in a shoulder part.

In the tire of the present invention, when, among the at least two inclined main grooves, the one which is arranged adjacent to the first inclined main groove on the tire rotation direction leading side is defined as a second inclined main groove, it is preferred that the center-side shallow groove extends between one end of the first inclined main groove and one end of the second inclined main groove. In the tire of the present invention, it is also preferred that the center-side shallow groove exists on the tire width direction inner side relative to the second inclined main groove. Further, in the tire of the present invention, it is preferred that the shoulder-side shallow groove is inclined in the same direction as the first and second inclined main grooves; and that the center-side shallow groove is also inclined in the same direction as the first and second inclined main grooves. The tire of the present invention is suitably used as a rear tire.

### Effects of the Invention

According to the present invention, a motorcycle tire whose wear resistance and drainage performance are improved as compared to conventional motorcycle tires can be realized.

### BRIEF DESCRIPTION OF THE DRAWINGS

FIG. 1 is one example of a partial development view illustrating the tread section of a motorcycle tire according to one preferred embodiment of the present invention.

FIG. 2 is one example of a cross-sectional view taken along the width direction of a motorcycle tire according to one preferred embodiment of the present invention.

### MODE FOR CARRYING OUT THE INVENTION

The motorcycle tire of the present invention will now be described in detail referring to the drawings.

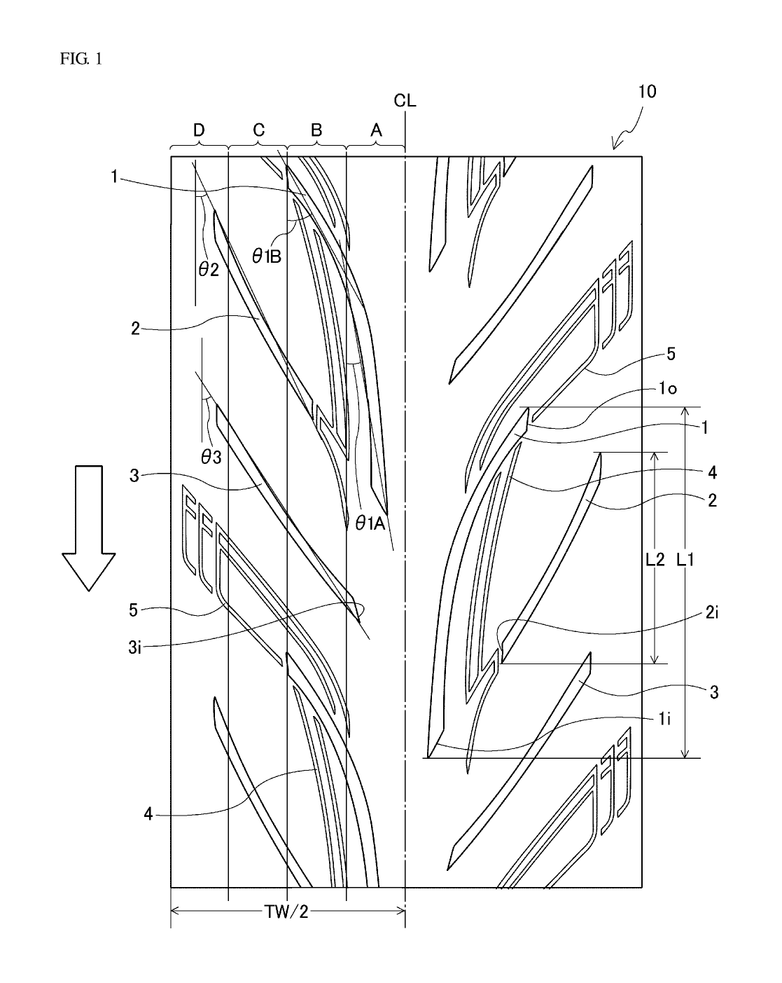

The motorcycle tire of the present invention comprises: a tread section; and side wall sections and bead sections that continuously extend on both sides of the tread section, and whose rotation direction when fitted to a motorcycle is designated, and the motorcycle tire of the present invention exerts its effects most prominently when used as a rear tire. FIG. 1 is one example of a partial development view illustrating the tread section of a motorcycle tire according to one preferred embodiment of the present invention, and the arrow drawn therein represents the rotation direction of the tire.

As illustrated in FIG. 1, in the tire of the present invention, at least two inclined main grooves (three inclined main grooves 1, 2 and 3 in the illustrated example) which are inclined with respect to the tire circumferential direction, and at least two shallow grooves 4 and 5 are arranged on the surface of a tread section 10. In the present invention, among the three inclined main grooves 1, 2 and 3, the one whose tire width direction inner end is closest to the tire equatorial plane CL is defined as “a first inclined main groove 1”, and the other two inclined main grooves are defined as “a second inclined main groove 2” and “a third inclined main groove 3” sequentially from the side of the first inclined main groove 1 toward the leading side of the tire rotation direction.

In the tire of the present invention, the at least two shallow grooves comprise: a center-side shallow groove 4, which exists on the tire width direction outer side relative to the first inclined main groove 1 and at least in a central part; and a shoulder-side shallow groove 5, which exists on the tire width direction inner side relative to the first inclined main groove 1 and at least in a shoulder part. By arranging the shallow grooves 4 and 5, the drainage performance can be further improved. The shallow grooves are preferably arranged on the force input side of each block; however, when the shallow grooves are arranged on the force input side of the block in the central part, the rigidity is reduced and this leads to a reduction in wear resistance. Therefore, in the present invention, the shoulder-side shallow groove 5 is arranged on the tire width direction inner side relative to the first inclined main groove 1 in the shoulder part, that is, on the force input side of each block, and the center-side shallow groove 4 is arranged on the tire width direction outer side relative to the first inclined main groove 1 in the central part, that is, on the force output side of each block. This enables to improve the drainage performance without reducing the wear resistance. Further, by allowing the shallow grooves 4 and 5 to have a depth of 0.1 to 0.5 mm, the drainage performance can be favorably improved while maintaining the rigidity of the tread section.

In the present invention, the shallow grooves 4 and 5 refer to grooves having a depth of 10% or less with respect to the depth of the respective inclined main grooves.

In the present invention, as illustrated in FIG. 1, it is preferred that the center-side shallow groove 4 extends between one end of the first inclined main groove 1 and one end of the second inclined main groove 2. By arranging a shallow groove in this manner such that it extends between the ends of two inclined main grooves, since water is drained into the inclined main grooves along the shallow groove, water is more efficiently drained, which is preferred. More specifically, in the illustrated example, the center-side shallow groove 4 extends between a tire width direction outer end 1o of the first inclined main groove 1 and a tire width direction inner end 2i of the second inclined main groove 2.

It is also preferred that the center-side shallow groove 4 exists on the tire width direction inner side relative to the second inclined main groove 2. The reason for this is because, by making sure that the center-side shallow groove 4 is arranged inside the ground contact region when the tire is put in an upright position, the hydroplaning phenomenon during high-speed travel is effectively inhibited.

Further, it is preferred that the center-side shallow groove 4 and the shoulder-side shallow groove 5 are both inclined in the same direction as the first inclined main groove 1 and the second inclined main groove 2. By inclining the extending directions of the shallow grooves in the same direction as the first inclined main groove 1 and the second inclined main groove 2, drainage paths can be provided in the direction close to the normal line with respect to the outline of the ground contact surface, which is preferred from the standpoint of further improving the drainage performance.

In the tire of the present invention, the center-side shallow groove 4 and the shoulder-side shallow groove 5 play an auxiliary role of the first, second and third inclined main grooves 1, 2 and 3 during drainage; however, the shapes of the shallow grooves 4 and 5 are not particularly restricted. For example, in the illustrated example, the center-side shallow groove 4 and the shoulder-side shallow groove 5 are both not in communication with any of the inclined main grooves and are thus independent grooves terminated within a block; however, the center-side shallow groove 4 and/or the shoulder-side shallow groove 5 may be in communication with any one of the inclined main grooves.

In the illustrated example, the center-side shallow groove 4 is arranged inclined in the same direction as the first inclined main groove 1 and the second inclined main groove 2 such that it extends between the end 1o of the first inclined main groove 1 and the end 2i of the second inclined main groove 2, and the portion arranged in the vicinity of the end 1o of the first inclined main groove 1 consists of two substantially parallel grooves, while the portion in the vicinity of the end 2i of the second inclined main groove 2 consists of a single groove which extends in the direction that extends and connects with the end 2i of the second inclined main groove 2. In the illustrated example, the shoulder-side shallow groove 5 is arranged inclined in the same direction as the first inclined main groove 1 and the second inclined main groove 2 such that it extends from the vicinity of the tire width direction outer end 1o of the first inclined main groove 1 toward the shoulder part, and the portion arranged in the vicinity of the end 1o of the first inclined main groove 1 consists of three substantially parallel grooves which have a shape of extending in the direction that extends and connects with the end 1o of the first inclined main groove 1 and being closed in the shoulder part. Alternatively, for example, the center-side shallow groove 4 and the shoulder-side shallow groove 5 may each have a shape of a single straight line or a single curved line.

In the illustrated tire of the present invention, the first inclined main groove 1 is arranged in a linear or curved shape, and the second inclined main groove 2 and the third inclined main groove 3 are arranged in a linear shape and substantially parallel to each other. By forming these inclined main grooves in a linear or curved shape with no bending point, smooth drainage along the grooves is facilitated, so that the wet performance can be improved. In addition, by arranging the second inclined main groove 2 and the third inclined main groove 3 substantially parallel to each other, the land portion (block) defined by the grooves is allowed to have a substantially parallelogram shape and the block rigidity is thereby ensured, so that the tire behaves stably against input force.

In the illustrated tire of the present invention, when viewed from the tire width direction, the second inclined main groove 2 completely overlaps with the first inclined main groove 1. By arranging the second inclined main groove 2 at a position that overlaps with the first inclined main groove 1 which is arranged more closely to the tire equatorial plane CL, drainage by the second inclined main groove 2 and drainage by the first inclined main groove 1 can be synchronized, so that the drainage performance can be further improved.

Further, in the illustrated tire of the present invention, a tire width direction inner end 3i of the third inclined main groove 3 is positioned between two tire width direction inner ends 1i of the first inclined main grooves 1 that are adjacent in the tire circumferential direction. By arranging the tire width direction inner end 3i of the third inclined main groove 3 between two tire width direction inner ends 1i of the first inclined main grooves 1 that are adjacent in the tire circumferential direction, the inclined main grooves can be arranged evenly arranged in the tire circumferential direction, so that good drainage performance can be ensured while uniformizing the wear resistance throughout the tire circumferential direction. Particularly, the tire width direction inner end 3i of the third inclined main groove 3 is more preferably positioned at a substantially midpoint between two tire width direction inner ends 1i of the first inclined main grooves 1 that are adjacent in the tire circumferential direction, and this enables to uniformize the wear resistance and to ensure good drainage performance throughout the tire circumferential direction. The phrase “positioned at a substantially midpoint” used herein means that, when the distance in the tire circumferential direction between the tire width direction inner ends 1i of the first inclined main grooves 1 that are adjacent to each other is defined as 100%, the tire width direction inner end 3i of the third inclined main groove 3 is positioned in a range of midpoint ±10%.

Therefore, in the tire of the present invention, by arranging three inclined main grooves of prescribed shapes in prescribed conditions, good drainage performance by the respective main grooves can be attained while ensuring the block rigidity and securing good wear resistance, and stable wear resistance and good drainage performance can be guaranteed throughout the tire circumferential direction, which are all preferred.

In the present invention, more specifically, as illustrated in FIG. 1, it is preferred that the inclined main grooves are each arranged as follows when four equal regions, which are obtained by dividing a tread half-width region TW/2 that spans from the tire equatorial plane CL to one end of the tread ground-contact region in the tire width direction, are defined as regions A, B, C, and D sequentially from the side of the tire equatorial plane. That is, by arranging the first inclined main groove 1 to span from the region A, which is the region closest to the tire equatorial plane, to the region B, the first inclined main groove 1 is allowed to contribute to the wet performance and the wear resistance. Further, by arranging the second inclined main groove 2 in the regions C and D, the second inclined main groove 2 is allowed to contribute to only the wet performance. Moreover, by arranging the third inclined main groove 3 in such a manner to extend from the region B to the regions C and D, the third inclined main groove 3 is allowed to contribute to the wet performance and the wear resistance. In the present invention, among the regions A, B, C, and D, the regions A and B correspond to the above-described central part, and the regions C and D correspond to the above-described shoulder part.

In the tire of the present invention, it is also preferred that the length L2 of the second inclined main groove 2 in the tire circumferential direction is not less than 50%, particularly 50 to 70%, with respect to the length L1 of the first inclined main groove 1 in the tire circumferential direction. By controlling the length L2 of the second inclined main groove 2 in the tire circumferential direction to be not less than 50% of the length L1 of the first inclined main groove 1 in the tire circumferential direction, the drainage performance by the second inclined main groove 2 can be sufficiently secured, and the wet performance can be further improved. The inclined main grooves may each have a depth of, for example, 4 to 7 mm. It is noted here that the depth of an inclined main groove means the depth at the deepest point of the inclined main groove.

Further, in the tire of the present invention, the first inclined main groove 1 has an inclination angle θ1A of preferably 0 to 20°, more preferably 5 to 15°, with respect to the tire circumferential direction in the region A, and an inclination angle θ1B of preferably 15 to 35°, more preferably 20 to 30°, with respect to the tire circumferential direction in the region B. The second inclined main groove 2 has an inclination angle θ2 of preferably 15 to 35°, more preferably 20 to 30°, with respect to the tire circumferential direction, and the third inclined main groove 3 has an inclination angle θ3 of preferably 50 to 70°, more preferably 55 to 65°, with respect to the tire circumferential direction. By setting the inclination angles of the inclined main grooves within the above-described respective ranges, the inclined main grooves are arranged in the direction close to the normal line with respect to the outline of the ground contact surface particularly in the regions C and the like, so that a driving force and a lateral force can be ensured, which is preferred.

In the present invention, the inclination angle of each inclined main groove with respect to the tire circumferential direction means an angle on the acute angle side of the angles that are formed by a straight line connecting the tire width direction ends of each inclined main groove with respect to the tire circumferential direction. As for the part of the first inclined main groove 1 in the boundary between the regions A and B, the inclination angle can be defined taking the midpoint of the groove width in the tire circumferential direction as one end in the tire width direction.

In the present invention, as illustrated in FIG. 1, from the standpoint of ensuring appropriate pattern rigidity in the vicinity of the tire equatorial plane and thereby improving the wear resistance, it is preferred that none of the inclined main grooves and shallow grooves is arranged on the tire equatorial plane.

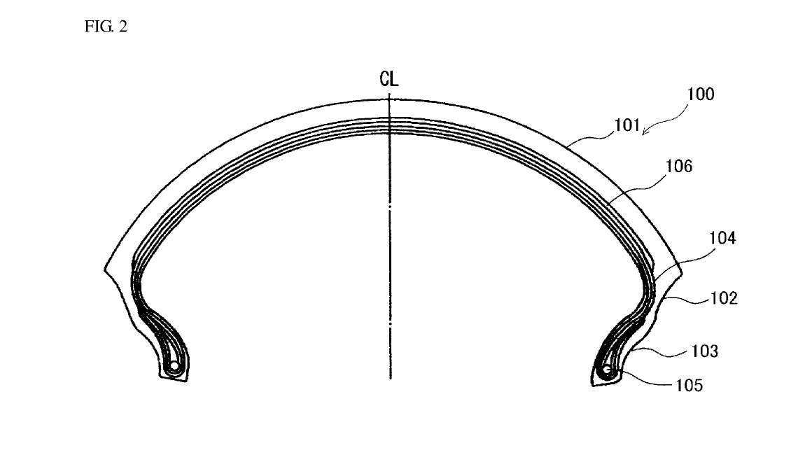

FIG. 2 is one example of a cross-sectional view taken along the width direction of a motorcycle tire according to one preferred embodiment of the present invention. As illustrated in FIG. 2, a tire 100 of the present invention comprises: a tread section 101; a pair of side wall sections 102, which continuously extend on both sides of the tread section 101; a pair of bead sections 103, which continuously extend from each of the pair of the side wall sections 102; and a carcass 104, which is composed of at least one carcass ply layer (two carcass ply layers in the illustrated example) reinforcing the above-described sections over the range between the bead sections 103. In the illustrated example, both ends of the carcass 104 are folded around a bead core 105 from the inside to the outside of the tire to be anchored; however, the ends of the carcass 104 may each be sandwiched and anchored by a bead wire.

Further, in the tire illustrated in FIG. 2, a belt layer 106 is arranged on the tire radial direction outer side of the carcass 104. The belt cord of the belt layer 106 is also not particularly restricted, and any known non-extensible high-elasticity cord can be used. For example, a cord made of an organic fiber such as an aromatic polyamide (aramid, e.g., trade name “Kevlar®” manufactured by DuPont), polyethylene naphthalate (PEN), polyethylene terephthalate (PET), rayon or nylon, or a material such as steel, glass fiber or carbon fiber, can be selected as appropriate. The belt layer 106 may be composed of two or more inclined belt layers which are arranged such that their cord directions intersect with each other between the layers, or may be composed of one or more spiral belt layers whose cord direction is substantially the same as the tire circumferential direction. The present invention is useful as a rear tire of a motorcycle and can also be applied to any of those tires having a radial structure or a bias structure.

### EXAMPLES

The present invention will now be described in more detail by way of examples thereof.

### Example 1

A motorcycle tire having a tread pattern of the type illustrated in FIG. 1 was produced at a size of 190/55ZR17. As illustrated, in this tire, a first inclined main groove 1 had a curved shape, and a second inclined main groove 2 and a third inclined main groove 3 had a linear shape and were arranged substantially parallel to each other. Further, in this tire, a center-side shallow groove 4 existing on the tire width direction outer side relative to the first inclined main groove 1 and at least in the central part and a shoulder-side shallow groove 5 existing on the tire width direction inner side relative to the first inclined main groove 1 and at least in the shoulder part were arranged as shallow grooves.

In this tire, the center-side shallow groove 4 and the shoulder-side shallow groove 5 were both inclined in the same direction as the first inclined main groove 1 and the second inclined main groove 2, and the center-side shallow groove 4 existed on the tire width direction inner side relative to the second inclined main groove 2, extending between one end of the first inclined main groove 1 and one end of the second inclined main groove 2. These shallow grooves 4 and 5 both had a depth of 0.3 mm, and the inclined main grooves all had a depth of 5.9 mm.

### Example 2

The test tire of Example 2 was produced in the same manner as in Example 1, except that the center-side shallow groove 4 was not arranged in such a manner to extend between one end of the first inclined main groove 1 and one end of the second inclined main groove 2.

### Example 3

The test tire of Example 3 was produced in the same manner as in Example 1, except that the center-side shallow groove 4 was arranged on the tire width direction outer side relative to the second inclined main groove 2.

### Example 4

The test tire of Example 4 was produced in the same manner as in Example 1, except that the shoulder-side shallow groove 5 was arranged inclined in the opposite direction of the first inclined main groove 1 and the second inclined main groove 2.

### Example 5

The test tire of Example 5 was produced in the same manner as in Example 1, except that the center-side shallow groove 4 was arranged inclined in the opposite direction of the first inclined main groove 1 and the second inclined main groove 2.

### Comparative Example 1

The test tire of Comparative Example 1 was produced in the same manner as in Example 1, except that no shallow groove was arranged.

### Comparative Example 2

The test tire of Comparative Example 2 was produced in the same manner as in Example 1, except that only the center-side shallow groove 4 existing on the tire width direction outer side relative to the first inclined main groove 1 and at least in the central part was arranged as a shallow groove.

### Comparative Example 3

The test tire of Comparative Example 3 was produced in the same manner as in Example 1, except that only the shoulder-side shallow groove 5 existing on the tire width direction inner side relative to the first inclined main groove 1 and at least in the shoulder part was arranged as a shallow groove.

The thus obtained test tires were each assembled to a wheel having a rim size of 6.0×17 inches, inflated to an inner pressure of 290 kPa and then fitted to a 1,000-cc motorcycle as the rear tire. As the front tire, a conventional tire was fitted. The front tire had a size of 120/70ZR17, a rim size of 3.5×17 inches and an inner pressure of 250 kPa. This motorcycle was driven on a test track, and the drainage performance of the rear tire on wet road and the tire wear resistance were evaluated by the following methods.

### <Wear Resistance>

After the completion of the driving test performed by a test rider, the wear amount of each tire was measured using a depth gauge and compared. The results thereof are shown as index values where a value of 100 represents the wear amount of the tire of Comparative Example 1. A larger value indicates superior wear resistance.

### <Drainage Performance>

The strength of the gripping force of each tire on wet road and the change in the gripping strength in response to tilting of the tire were evaluated by the test rider based on the feeling. The results thereof are shown as index values where a value of 100 represents the tire of Comparative Example 1. A larger value indicates superior drainage performance.

TABLE 1

| | | | | | Inclination | | | |
|---|---|---|---|---|---|---|---|---|
| | | | | | direction of | Inclination direction | | |
| | Presence or | Presence or | | Position of | shoulder-side | of center-side | | |
| | absence of | absence of | Position of | center-side shallow | shallow groove | shallow groove with | | |
| | center-side | shoulder-side | center-side | groove relative to | with respect to first | respect to first and | Wear | Drainage |
| | shallow | shallow | shallow | second inclined | and second inclined | second inclined | resistance | performance |
| | groove | groove | groove*¹ | main groove | main grooves | main grooves | (index) | (index) |
| Example 1 | present | present | between | tire width direction | same | same | 100 | 110 |
| | | | ends | inner side | | | | |
| Example 2 | present | present | not between | tire width direction | same | same | 100 | 105 |
| | | | ends | inner side | | | | |
| Example 3 | present | present | between | tire width direction | same | same | 100 | 103 |
| | | | ends | outer side | | | | |
| Example 4 | present | present | between | tire width direction | opposite | same | 100 | 103 |
| | | | ends | inner side | | | | |
| Example 5 | present | present | between | tire width direction | same | opposite | 100 | 103 |
| | | | ends | inner side | | | | |
| Comparative | absent | present | between | tire width direction | same | same | 100 | 100 |
| Example 1 | | | ends | inner side | | | | |
| Comparative | present | absent | between | tire width direction | same | same | 90 | 105 |
| Example 2 | | | ends | inner side | | | | |
| Comparative | absent | present | between | tire width direction | same | same | 100 | 95 |
| Example 3 | | | ends | inner side | | | | |

*¹This indicates whether or not the center-side shallow groove was arranged in such a manner to extend between one end of the first inclined main groove and one end of the second inclined main groove.

From the results shown in Table above, it was confirmed that the tire of the present invention has excellent wear resistance and excellent drainage performance.

### DESCRIPTION OF SYMBOLS

1: first inclined main groove

1i: tire width direction inner end of first inclined main groove

1o: tire width direction outer end of first inclined main groove

2: second inclined main groove

2i: tire width direction inner end of second inclined main groove

3: third inclined main groove

3i: tire width direction inner end of third inclined main groove

4: center-side shallow groove

5: shoulder-side shallow groove

10: tread section

100: tire

101: tread section

102: side wall section

103: bead section

104: carcass

105: bead core

106: belt layer

1. A motorcycle tire which comprises: a tread section; and side wall sections and bead sections that continuously extend on both sides of said tread section, and whose rotation direction when fitted to a motorcycle is designated, wherein
at least two inclined main grooves that are inclined with respect to the tire circumferential direction and at least two shallow grooves are arranged on the surface of said tread section; and
when, among said at least two inclined main grooves, the one whose tire width direction inner end is closest to the tire equatorial plane is defined as a first inclined main groove, said at least two shallow grooves comprise: a center-side shallow groove which exists on the tire width direction outer side relative to said first inclined main groove and at least in a central part; and a shoulder-side shallow groove which exists on the tire width direction inner side relative to said first inclined main groove and at least in a shoulder part.

2. The motorcycle tire according to claim 1, wherein when, among said at least two inclined main grooves, the one which is arranged adjacent to said first inclined main groove on the tire rotation direction leading side is defined as a second inclined main groove, said center-side shallow groove extends between one end of said first inclined main groove and one end of said second inclined main groove.

3. The motorcycle tire according to claim 2, wherein said center-side shallow groove exists on the tire width direction inner side relative to said second inclined main groove.

4. The motorcycle tire according to claim 2, wherein said shoulder-side shallow groove is inclined in the same direction as said first inclined main groove and said second inclined main groove.

5. The motorcycle tire according to claim 2, wherein said center-side shallow groove is inclined in the same direction as said first inclined main groove and said second inclined main groove.

6. The motorcycle tire according to claim 1, which is used as a rear tire.
